(19) United States
(12) Patent Application Publication
(10) Pub. No.: US 2015/0029408 A1
(43) Pub. Date: Jan. 29, 2015

(54) UNIT WHICH HAS A CONNECTION TERMINAL AND AN ELECTRONIC DEVICE

(71) Applicant: KABUSHIKI KAISHA TOSHIBA, Tokyo (JP)

(72) Inventors: Hajime Suzuki, Hamura-shi (JP); Koji Shingu, Fukaya-shi (JP); Yuuji Ono, Hamura-shi (JP); Masahiro Kobayashi, Kazo-shi (JP); Noriaki Sakamoto, Fukaya-shi (JP)

(73) Assignee: KABUSHIKI KAISHA TOSHIBA, Tokyo (JP)

(21) Appl. No.: 14/137,730

(22) Filed: Dec. 20, 2013

Related U.S. Application Data
(60) Provisional application No. 61/858,025, filed on Jul. 24, 2013.

(51) Int. Cl. H04N 5/64

(52) U.S. Cl. CPC H04N 5/64
USPC 348/836

(57) ABSTRACT

According to one embodiment, a unit includes a casing and a connection terminal. The casing has a first surface, a second surface opposite to the first surface, and an attachment hole. The connection terminal has a connection portion which is inserted through the attachment hole from the side of the second surface and thus protrudes on the side of the first surface, a flange which is provided at the proximal end of the connection portion and which has a size that does not allow the passage of the flange through the attachment hole, and a holding portion which holds the casing between this holding portion and the flange located on the side of the second surface opposite to the first surface.

### CROSS-REFERENCE TO RELATED APPLICATIONS

This application claims the benefit of U.S. Provisional Application No. 61/858,025, filed Jul. 24, 2013, the entire contents of which are incorporated herein by reference.

### FIELD

Embodiments described herein relate generally to a terminal unit which has a casing to which an antenna terminal of a tuner is fixed and an electronic device including the terminal unit mounted on a substrate.

### BACKGROUND

A tuner of a television has, for example, a shield case covering a tuner circuit on a substrate, and has a structure in which an antenna terminal is fixed to the shield case. The antenna terminal is generally attached from the outside of the shield case and then fixed to the shield case.

Therefore, if an antenna cable connected to the antenna terminal is pulled, a high load may be imposed on the antenna terminal, and the antenna terminal may come off the shield case.

Particularly when the antenna cable is screwed to the antenna terminal, tensile force acting on the antenna cable is directly transmitted to the antenna terminal (without the coming off of the antenna cable), and strong force in a pullout direction thus acts on the antenna terminal, which may be a cause of a failure.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary exterior perspective view showing a television as an example of an electronic device according to an embodiment;

FIG. 2 is an exemplary exterior perspective view showing a main substrate incorporated in the television in FIG. 1;

FIG. 3 is an exemplary rear view of the main substrate in FIG. 2;

FIG. 4 is an exemplary partial perspective view of a shield case mounted on the main substrate in FIG. 2 without a top plate;

FIG. 5 is an exemplary partial enlarged perspective view showing how the shield case in FIG. 4 is separated from the substrate;

FIG. 6 is an exemplary exploded perspective view illustrating a structure according to a first embodiment for attaching an antenna terminal to a support plate of the shield case in FIG. 4;

FIG. 7 is an exemplary perspective view showing how the antenna terminal in FIG. 6 is attached to the support plate;

FIG. 8 is an exemplary plan view showing the support plate in FIG. 6;

FIG. 9A is an exemplary plan view of the antenna terminal in FIG. 6;

FIG. 9B is an exemplary side view of the antenna terminal in FIG. 6;

FIG. 10 is an exemplary operation explaining diagram illustrating an operation of attaching the antenna terminal in FIG. 6;

FIG. 11 is an exemplary exploded perspective view illustrating a structure for attaching an antenna terminal according to a second embodiment;

FIG. 12 is an exemplary perspective view showing how the antenna terminal in FIG. 11 is attached to a support plate;

FIG. 13 is an exemplary plan view showing the support plate in FIG. 11;

FIG. 14A is an exemplary plan view of the antenna terminal in FIG. 11;

FIG. 14B is an exemplary side view of the antenna terminal in FIG. 11;

FIG. 15 is an exemplary operation explaining diagram illustrating an operation of attaching the antenna terminal in FIG. 11;

FIG. 16 is an exemplary exploded perspective view illustrating a structure for attaching an antenna terminal according to a third embodiment;

FIG. 17 is an exemplary perspective view showing how the antenna terminal in FIG. 16 is attached to a support plate;

FIG. 18 is an exemplary plan view showing the support plate in FIG. 16;

FIG. 19A is an exemplary plan view of the antenna terminal in FIG. 16;

FIG. 19B is an exemplary side view of the antenna terminal in FIG. 16;

FIG. 20 is an exemplary exploded view showing the relation between engaging grooves of the antenna terminal in FIG. 16 and projections of the support plate;

FIG. 21 is an exemplary assembly diagram showing how the antenna terminal in FIG. 20 is attached to the support plate;

FIG. 22 is an exemplary exploded perspective view illustrating a structure for attaching an antenna terminal according to a fourth embodiment;

FIG. 23 is an exemplary perspective view showing how the antenna terminal in FIG. 22 is attached to a support plate;

FIG. 24 is an exemplary plan view showing the support plate in FIG. 22;

FIG. 25A is an exemplary plan view of the antenna terminal in FIG. 22;

FIG. 25B is an exemplary side view of the antenna terminal in FIG. 22;

FIG. 26 is an exemplary exploded perspective view illustrating a modification of the attachment structures according to the first to fourth embodiments;

FIG. 27 is an exemplary perspective view showing how an antenna terminal in FIG. 26 is attached to a shield case and then mounted on a substrate;

FIG. 28A is an exemplary plan view of the antenna terminal in FIG. 26; and

FIG. 28B is an exemplary side view of the antenna terminal in FIG. 26.

### DETAILED DESCRIPTION

Various embodiments will be described hereinafter with reference to the accompanying drawings.

In general, according to one embodiment, a unit includes a casing and a connection terminal. The casing has a first surface, a second surface opposite to the first surface, and an attachment hole. The connection terminal has a connection portion which is inserted through the attachment hole from the side of the second surface and thus protrudes on the side of the first surface, a flange which is provided at the proximal end of the connection portion and which has a size that does not allow the passage of the flange through the attachment hole, and a holding portion which holds the casing between this holding portion and the flange located on the side of the second surface opposite to the first surface.

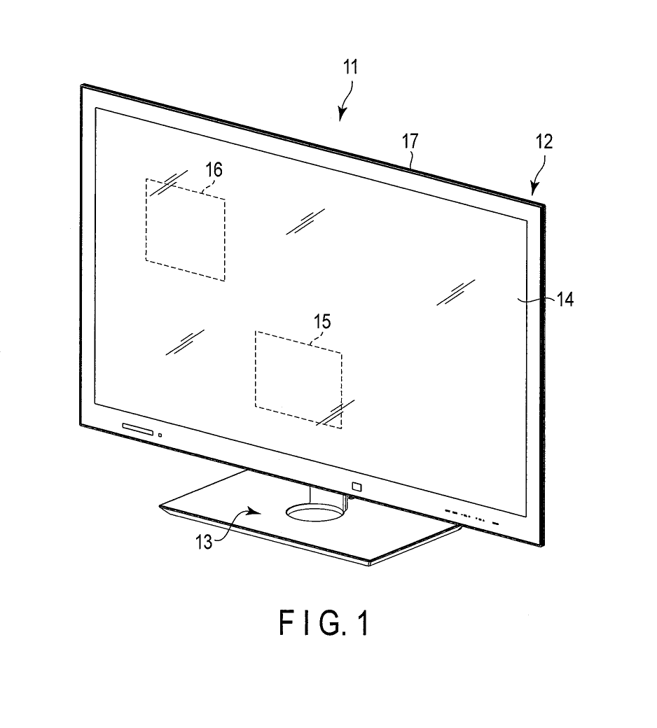

FIG. 1 is an exemplary exterior perspective view of a television 11 which is an example of an electronic device according to an embodiment.

The television 11 comprises a thin display 12 in the shape of a rectangular plate, and a stand 13 which supports the display 12.

The display 12 comprises a display panel 14, a main substrate 15 (substrate) provided on the rear surface of the display panel 14, a power supply substrate 16 provided in the rear surface of the display panel 14, and a case 17 which covers the display panel 14, the main substrate 15, and the power supply substrate 16.

In the present embodiment, the display panel 14 is, for example, a liquid crystal panel in the shape of a rectangular plate. Otherwise, the display panel 14 may be a display panel of some other kind such as a plasma display panel, an organic EL panel, or an LED panel.

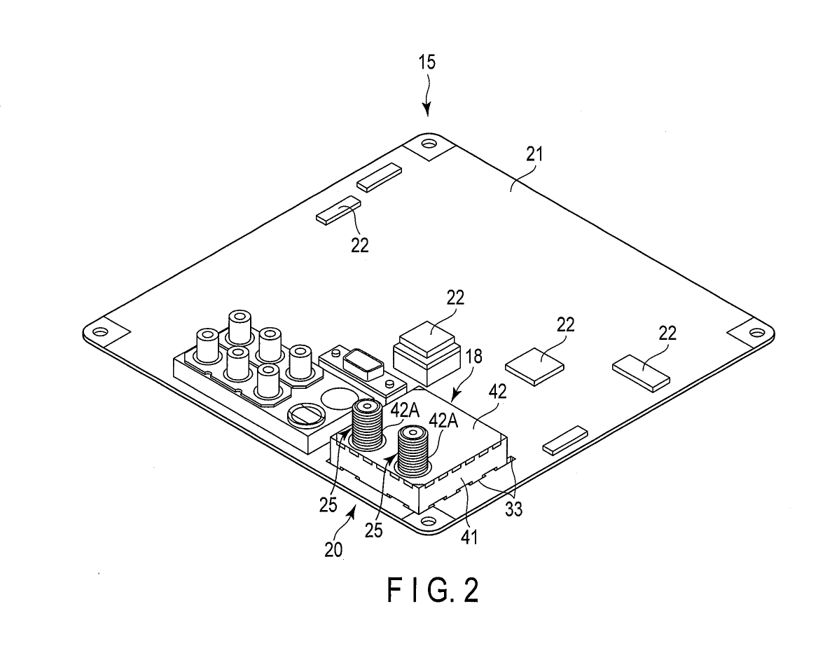

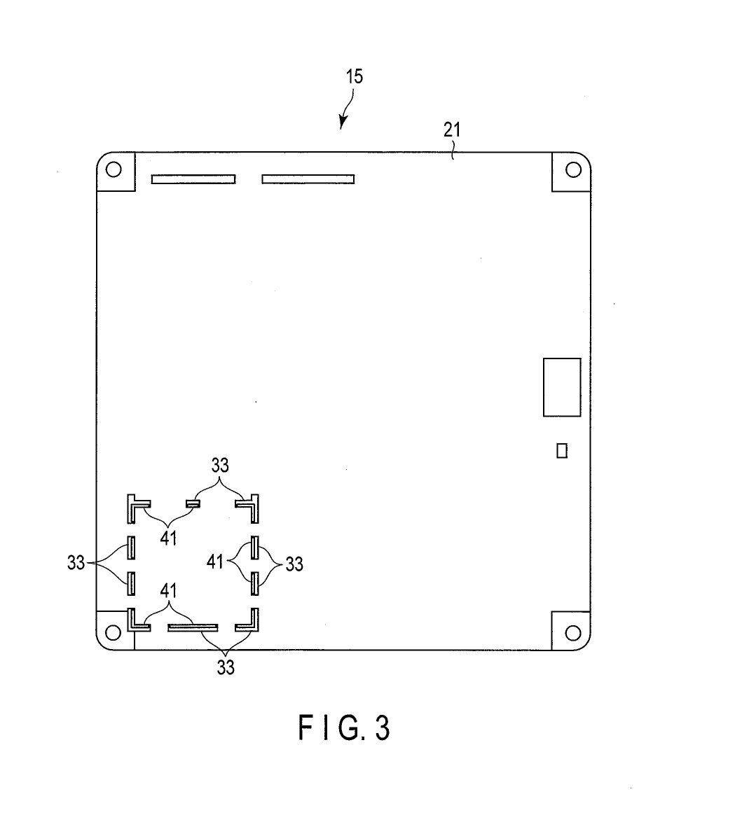

FIG. 2 is an exemplary exterior perspective view showing the main substrate 15 from its mounting side. FIG. 3 is an exemplary rear view of the main substrate 15 seen from its rear side. The main substrate 15 is attached to an unshown chassis so that the rear surface shown in FIG. 3 faces the rear surface of the display panel 14.

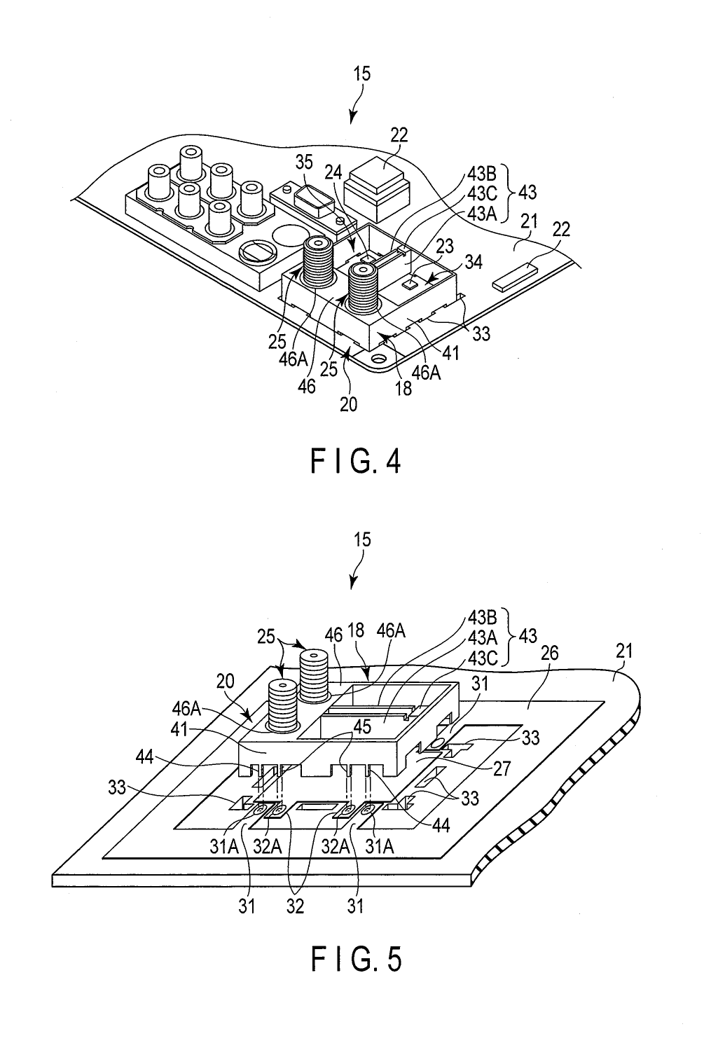

The main substrate 15 comprises a substantially rectangular substrate 21, a plurality of electronic components 22 (e.g. a CPU, a ROM, and a RAM) mounted on the substrate 21, a first tuner 23 and a second tuner 24 (see FIG. 4) mounted on the substrate 21, a shield case 18 (casing) provided on the substrate 21 around the first tuner 23 and the second tuner 24, and a pair of antenna terminals 25, 25 (connection terminals) fixed to the shield case 18 to protrude from the top of the shield case 18.

The shield case 18 comprising the two antenna terminals 25, 25 functions as a terminal unit 20 (unit). In the present embodiment, the first tuner 23 and the second tuner 24 are mounted on the main substrate 15, and no substrate exclusive to the tuners is needed. However, it is possible to use a configuration in which a small substrate prepared exclusively for the tuners is mounted on the main substrate 15.

FIG. 4 is an exemplary partial perspective view of the main substrate 15 without a top plate 42 (FIG. 2) of the shield case 18 of the terminal unit 20. The first tuner 23 is what is known as a high-frequency component, and constitutes part of, for example, a satellite broadcast receiving circuit 34. Similarly, the second tuner 24 is what is known as a high-frequency component, and constitutes part of, for example, a terrestrial analog/digital broadcast receiving circuit 35. The first tuner 23 and the second tuner 24 are disposed inside the shield case 18.

The first tuner 23 for receiving satellite broadcast may be absent, and the second tuner 24 for receiving terrestrial broadcast alone may be provided. In this case, the terminal unit 20 only has a single antenna terminal 25 connected to the second tuner 24 (not shown).

As shown in FIG. 3 and FIG. 5, the substrate 21 is provided with a plurality of slots 33 for the attachment of the shield case 18. These slots 33 are annularly arranged around a second ground 27 provided on the substrate 21.

A first ground 26 is provided outside the second ground 27. In other words, the slots 33 are arranged between the second ground 27 and the first ground 26 provided outside the second ground 27, and a region inside the shield case 18 is separated from other regions of the main substrate 15.

The first ground 26 is formed into a planar shape on the substrate 21 by a conductor layer (copper thin film). A plurality of first protrusions 31 protruding inward from the inner edge of the first ground 26 toward the second ground 27 are electrically connected to the shield case 18.

The second ground 27 is formed into a planar shape on the substrate 21 by a conductor layer (copper thin film). A plurality of second protrusions 32 protruding outward from the outer circumferential edge of the second ground 27 toward the first ground 26 are electrically connected to the shield case 18.

On the other hand, the shield case 18 is formed by bending a conductive material such as a sheet metal (plated steel plate) into a box shape. The shield case 18 has a side portion 41 provided in the shape of a frame erected on the substrate 21, the top plate 42 removable from the side portion 41, a divider 43 which divides the inside of the side portion 41 into two regions, first projections 44 and second projections 45 provided in the side portion 41, and a support plate 46 which is parallel to the substrate 21 and to which the pair of antenna terminals 25, 25 are fixed.

As shown in FIG. 2, the top plate 42 has two holes 42A, 42A through which the pair of antenna terminals 25, 25 is inserted. The support plate 46 has two attachment holes 46A, 46A for the attachment of the pair of antenna terminals 25, 25. That is, the two attachment holes 46A, 46A of the support plate 46 coaxially overlap the two holes 42A, 42A of the top plate 42, respectively, and the support plate 46 supporting the pair of antenna terminals 25, 25 is covered with the top plate 42.

As shown in FIG. 4 and FIG. 5, the divider 43 is formed by bending a conductive material such as a sheet metal (plated steel plate) in the center, and has two pieces constituting a double shield. The divider 43 has a first piece 43A, a second piece 43B separate from the first piece 43A, and a coupling piece 43C which couples the first piece 43A to the second piece 43B.

As shown in FIG. 5, the first projections 44 protrude toward the first protrusions 31, and are passed through through-holes 31A provided in the first protrusions 31. The first projections 44 are electrically connected to the first protrusions 31 via solder. As a result, the shield case 18 is electrically connected to the first ground 26.

The second projections 45 protrude toward the second protrusions 32, and are passed through through-holes 32A provided in the second protrusions 32. The second projections 45 are electrically connected to the second protrusions 32 via solder. As a result, the shield case 18 is electrically connected to the second ground 27.

Therefore, in the present embodiment, the first ground 26 is electrically connected to the second ground 27 via the shield case 18. The shield case 18 is fixed to the substrate 21 by inserting the projections 44 and 45 through the through-holes 31A and 32A and soldering.

Several embodiments are shown to described below a structure for attaching the pair of antenna terminals 25, 25 to the support plate 46 of the shield case 18. As the two antenna terminals 25, 25 have the same attachment structures, one of the antenna terminals is only shown and described by way of example here. Components which function in the same manner as the components in the embodiment described above are indicated by the same reference signs in the following explanation, and repeated explanations are not given.

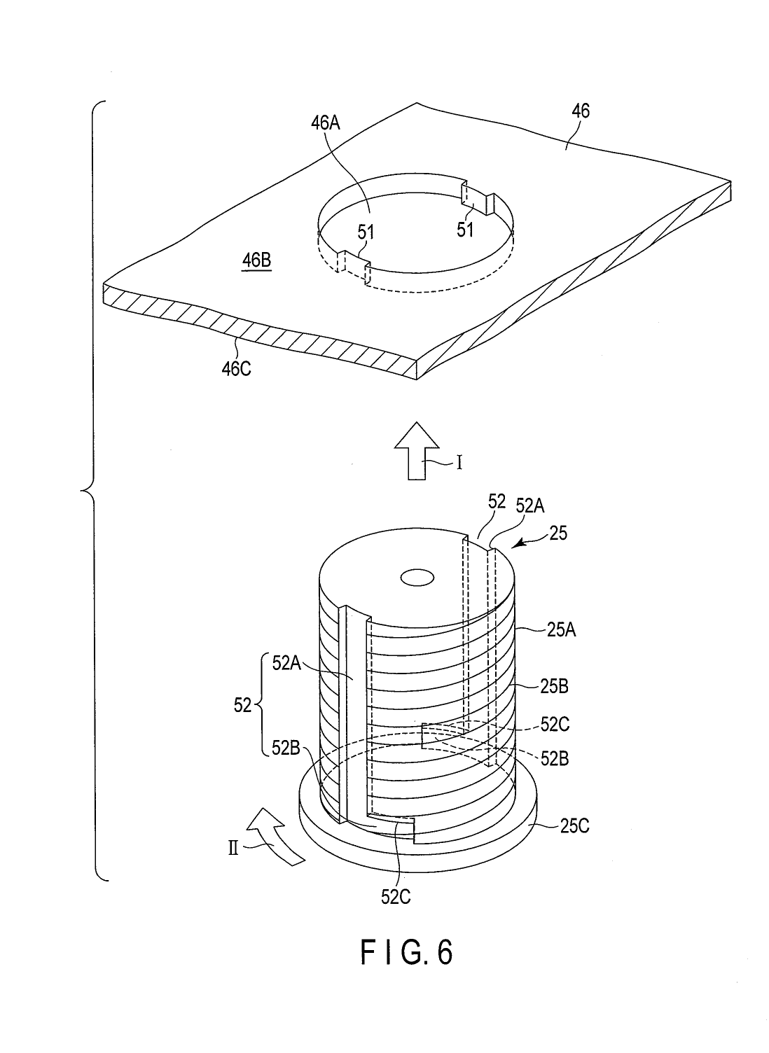

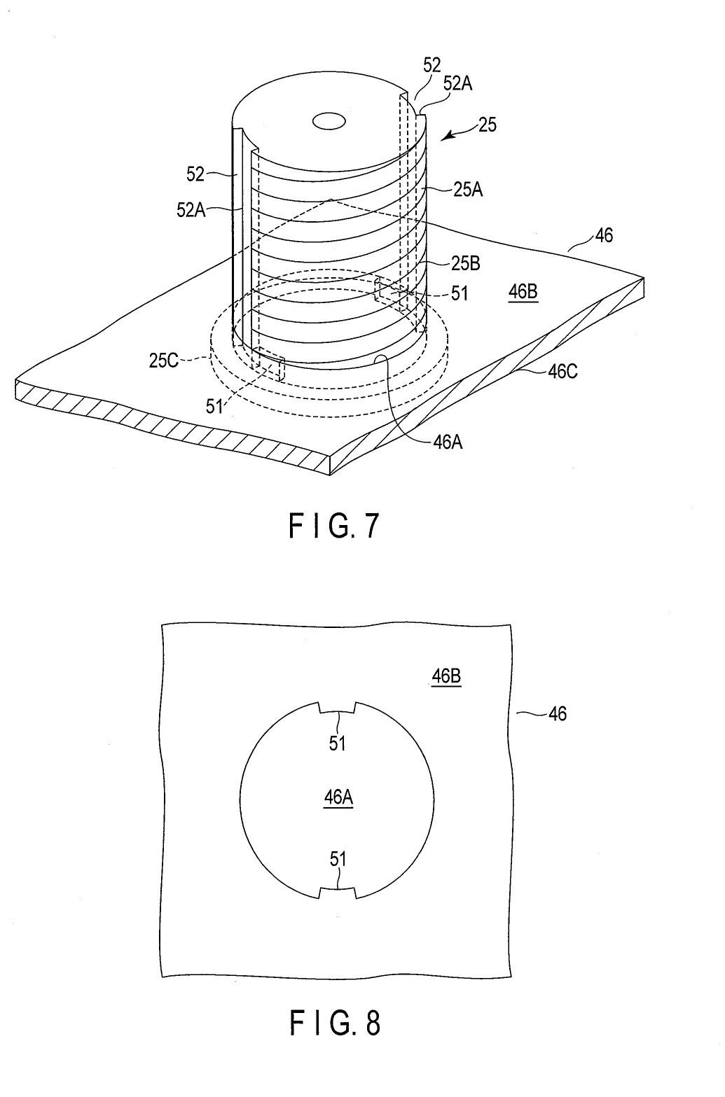

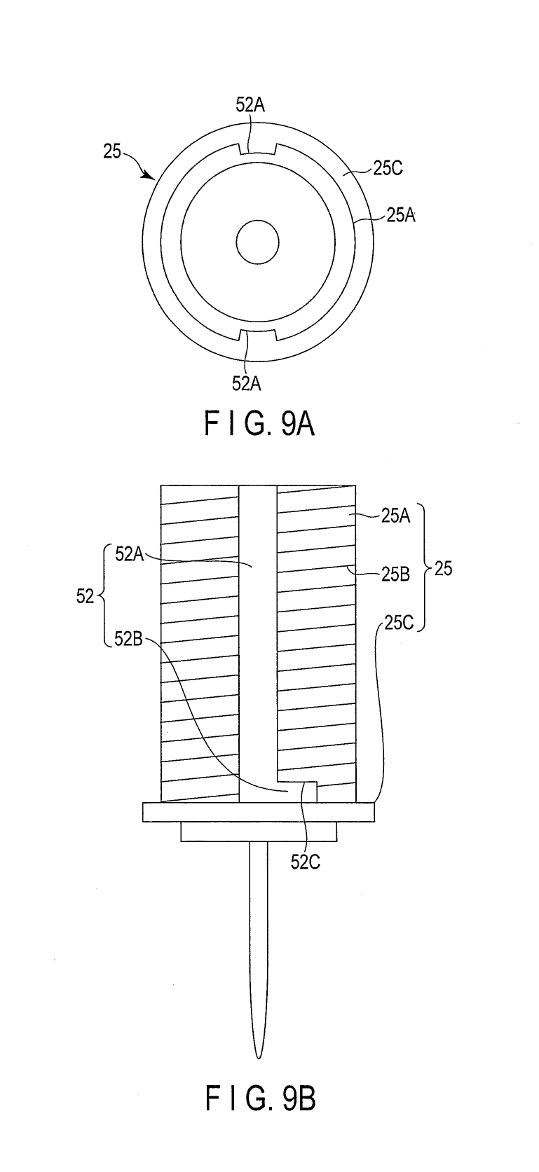

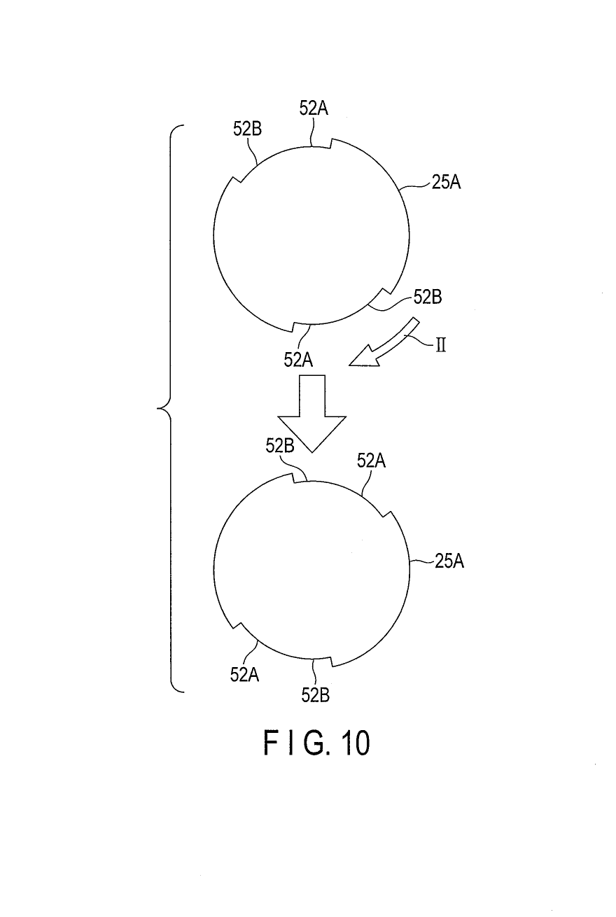

An attachment structure according to a first embodiment is described with reference to FIG. 6 to FIG. 10. FIG. 6 is an exemplary exploded perspective view showing the part located in the vicinity of the attachment hole 46A of the support plate 46 in partially enlarged form, and also showing the antenna terminal 25 separated from the support plate 46. FIG. 7 is an exemplary perspective view showing how the antenna terminal 25 in FIG. 6 is attached to the attachment hole 46A of the support plate 46. FIG. 8 is an exemplary plan view of the support plate 46 in FIG. 6. FIG. 9A is an exemplary plan view of the antenna terminal 25 seen from an insertion/removal direction of an unshown antenna cable. FIG. 9B is an exemplary side view of the antenna terminal 25. FIG. 10 is an exemplary operation explaining diagram illustrating an operation of attaching the antenna terminal 25.

The support plate 46 has a first surface 46B, a second surface 46C opposite to the first surface 46B. The attachment hole 46A is substantially circular, and extend through the support plate 46 to link the first surface 46B and the second surface 46C. The first surface 46B is a surface facing the top plate 42, and 9i09i0 the second surface 46C is a surface facing the substrate 21.

In the present embodiment, the support plate 46 has two projections 51, 51 protruding inward from the edge of the attachment hole 46A. The two projections 51, 51 are located to face each other point-symmetrically with respect to the center of the attachment hole 46A. The number of the projections 51 is not limited to two. One projection 51 or three or more projections 51 may be provided. The projections 51 have only to be provided apart from one another in the circumferential direction of the attachment hole 46A.

The antenna terminal 25 has a substantially cylindrical connection portion 25A. The connection portion 25A is inserted through the attachment hole 46A from the side of the second surface 46C of the support plate 46, and protrudes on the side of the first surface 46B. A thread groove 25B for connecting the terminal of the unshown antenna cable is provided in the outer circumferential surface of the connection portion 25A. The outer diameter of the connection portion 25A is slightly smaller than the inner diameter of the attachment hole 46A of the support plate 46.

An annular flange 25C larger in diameter than the connection portion 25A is integrally provided at the proximal end of the connection portion 25A in an insertion direction (an arrow I direction in FIG. 6). The flange 25C has a size that does not allow the passage of the flange 25C through at least the attachment hole 46A of the support plate 46. The flange 25C faces the second surface 46C of the support plate 46 when the antenna terminal 25 is attached to the support plate 46 as shown in FIG. 7. The shape of the flange 25C is not exclusively circular.

As shown in FIG. 9B, L-shaped grooves 52 are provided in the outer circumferential surface of the connection portion 25A. The groove 52 has a longitudinal groove part 52A (first groove part) axially extending straight toward the flange 25C from the distal end of the connection portion 25A in the insertion direction I, and a lateral groove part 52B (second groove part) extending continuously from the longitudinal groove part 52A in the circumferential direction of the connection portion 25A along the flange 25C. Two shaped grooves 52 provided line-symmetrically with respect to the central axis of the connection portion 25A to correspond to the two projections 51, 51 of the support plate 46.

The lateral groove part 52B of each of the grooves 52 extends in such a direction as to be able to receive each projection 51 of the support plate 46 as shown in FIG. 7 when the connection portion 25A of the antenna terminal 25 is inserted through the attachment hole 46A of the support plate 46 and then rotated in an arrow II direction in FIG. 6. That is, after the connection portion 25A is inserted through the attachment hole 46A, the projection 51 is received in the lateral groove part 52B when the connection portion 25A is rotated in the right-hand thread direction (arrow II direction).

The antenna terminal 25 having the configuration described above can be formed, for example, by cutting a cylindrical elongated metallic material. In this case, the connection portion 25A is formed to leave the flange 25C having the largest diameter, and the thread groove 25B is formed on the outer circumferential surface of the connection portion 25A. The outer circumferential surface of the connection portion 25A is then cut, and two L-shaped grooves 52 are formed. Alternatively, the antenna terminal 25 can be integrally molded by the use of a predetermined die.

When the antenna terminal 25 having the configuration described above is attached to the attachment hole 46A of the support plate 46, the connection portion 25A of the antenna terminal 25 is first inserted through the attachment hole 46A from its distal end (opposite to the flange 25C) along the arrow I direction (axial direction) as shown in FIG. 6. At the same time, the two grooves 52, 52 are respectively aligned with the two projections 51, 51 of the attachment hole 46A, and the connection portion 25A is inserted through the attachment hole 46A from the side of the second surface 46C of the support plate 46. Each of the projections 51, 51 is slid along each of the longitudinal groove parts 52A, 52A of the grooves 52, 52, and the entire length of the connection portion 25A is then inserted through the attachment hole 46A. As a result, the flange 25C comes into contact with the second surface 46C of the support plate 46, and the connection portion 25A protrudes on the first surface 46B of the support plate 46.

Subsequently, the connection portion 25A of the antenna terminal 25 protruding on the side of the first surface 46B of the support plate 46 is rotated in the right-hand thread direction (arrow II direction in FIG. 10), and each of the two projections 51, 51 of the support plate 46 is slid on the lateral groove part 52B of each of the grooves 52. In this condition (condition in FIG. 7), the two projections 51, 51 in the attachment hole 46A abut on walls 52C (see FIG. 6 and FIG. 9B) located apart from the flange 25C of the lateral groove part 52B of each of the grooves 52, thereby preventing the connection portion 25A from coming off the attachment hole 46A.

The connection portion 25A is rotated in the opposite direction by slight force if the lateral groove part 52B is cut straight along the flange 25C so that each of the projections 51 is easily slidably received along the lateral groove part 52B of each of the grooves 52 when the connection portion 25A is rotated in the arrow II direction. In this case, each of the projections 51 may slide along the longitudinal groove part 52A, and the antenna terminal 25 may fall out of the attachment hole 46A.

Accordingly, in the present embodiment, the wall 52C is inclined toward the distal end of the lateral groove part 52B to approach the flange 25C so that the wall 52C of the lateral groove part 52B gradually presses the projection 51 toward the flange 25C when the connection portion 25A is rotated in the arrow II direction. In this case, the wall 52C of the lateral groove part 52B functions as a holding portion which holds the support plate 46 between this holding portion and the flange 25C.

As described above, according to the attachment structure in the present embodiment, no additional component is needed to fix the antenna terminal 25 to the support plate 46, the antenna terminal 25 can be robustly and easily fixed to the support plate 46 by a simple configuration, and the fall-out of the antenna terminal 25 can be effectively prevented.

In particular, according to the present embodiment, the connection portion 25A is inserted from the side of the second surface 46C of the support plate 46 and then brought into abutment with the second surface 46C of the support plate 46. Therefore, the antenna terminal 25 is not pulled out toward the first surface 46B of the support plate 46. Even if the unshown antenna cable connected to the antenna terminal 25 is pulled, there is no fear that the antenna terminal 25 may be easily detached from the support plate 46.

In particular, when the connection portion 25A of the antenna terminal 25 has the thread groove 25B as in the present embodiment, the antenna cable is firmly connected to the antenna terminal 25. Thus, if the antenna cable connected to the antenna terminal 25 is pulled, strong force in a pull-out direction acts on the antenna terminal 25. However, according to the attachment structure in the present embodiment, the antenna terminal 25 is not pulled out, and there is therefore no fear of the breakdown of the terminal unit 20.

Furthermore, according to the present embodiment, the L-shaped groove 52 cut in the connection portion 25A of the antenna terminal 25 has the lateral groove part 52B extending in such a direction as to receive the projection 51 when the connection portion 25A is rotated in the right-hand thread direction (arrow II). This eliminates the problem of the rotation of the antenna terminal 25 in a direction opposite to the attachment direction even if force in the right-hand thread direction is applied to the antenna terminal 25 during the attachment of the antenna cable.

In order for the attachment structure described above to be firmer, it is preferable to provide and fix solder cream between the outer circumferential portion of the flange 25C and the second surface 46C of the support plate 46 after the antenna terminal 25 is attached to the support plate 46 as shown in FIG. 7. When the antenna terminal 25 is thus soldered to the support plate 46, it is possible to obtain an electrically stable conducting property therebetween.

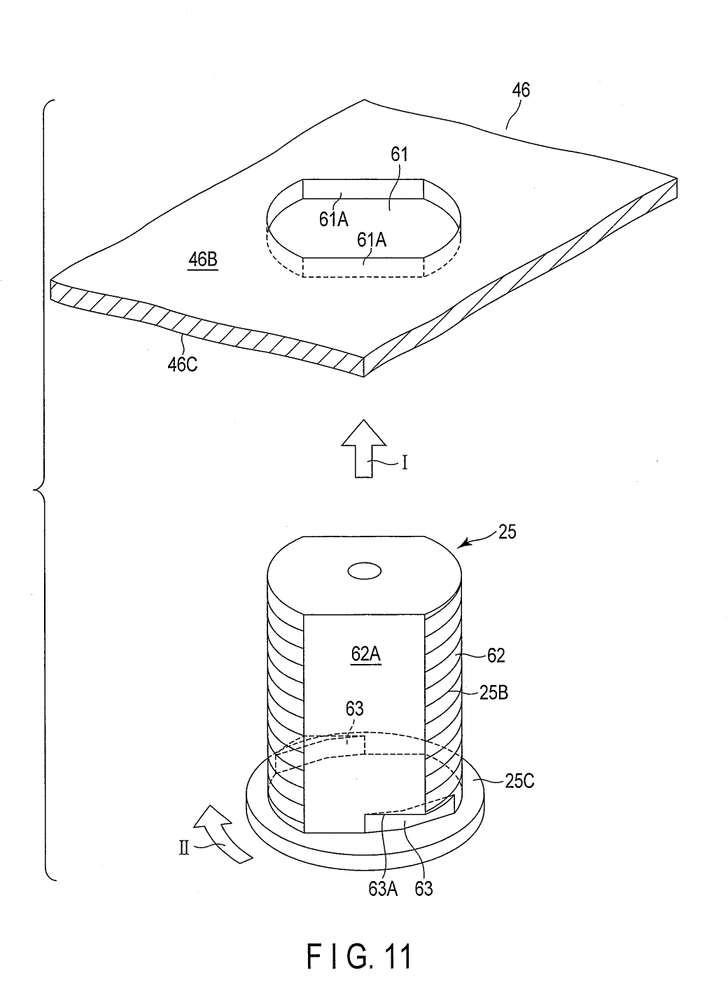

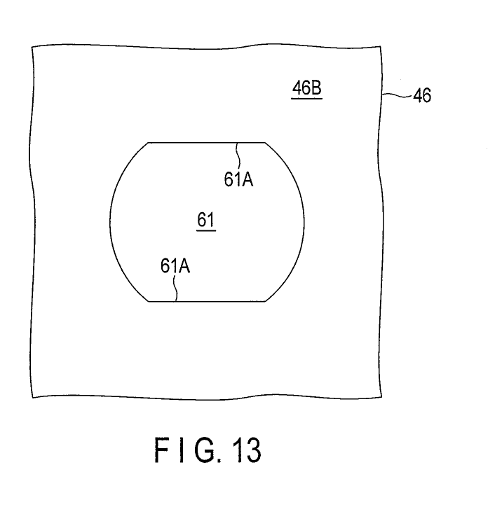

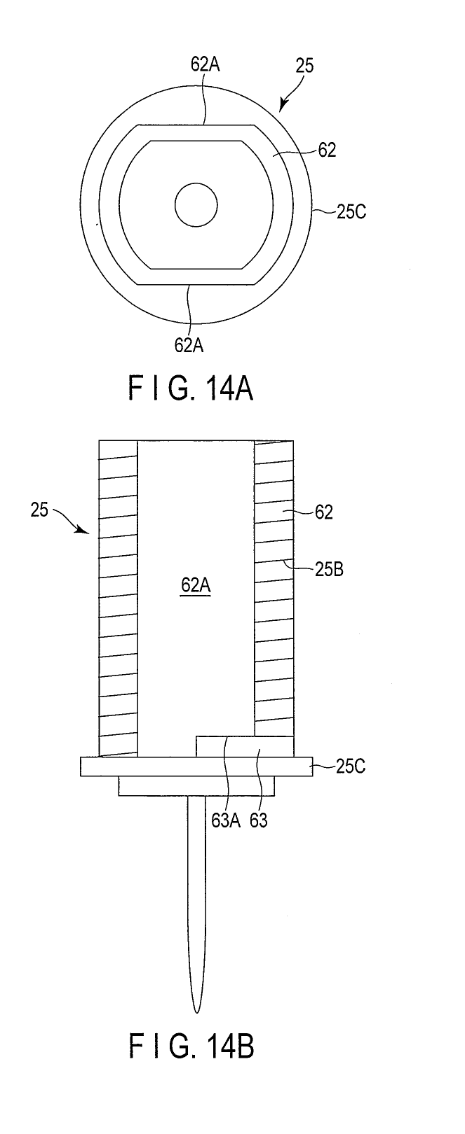

Now, an attachment structure according to a second embodiment is described with reference to FIG. 11 to FIG. 15. Here, components which function in the same manner as the components in the first embodiment described above are indicated by the same reference signs, and are not repeatedly described in detail. FIG. 11 to FIG. 15 respectively correspond to FIG. 6 to FIG. 10, and are therefore not explained here either.

According to the attachment structure in the present embodiment, the support plate 46 has a substantially elliptic attachment hole 61 for fixing the antenna terminal 25. More specifically, the attachment hole 61 has a drum-like opening shape in which a circle is cut by two lines extending parallel at equally distant positions in such a direction as to depart from the center of the circle. In the following explanation, two parallel edges of the attachment hole 61 defined by the parallel two lines are referred to as H-cut portions 61A.

On the other hand, the antenna terminal 25 has substantially the same sectional shape as the opening shape of the attachment hole 61 described above, and has a cylindrical connection portion 62 slightly smaller in diameter than the attachment hole 61. That is, this connection portion 62 has two parallel H-cut surfaces 62A, 62A corresponding to the H-cut portions 61A of the attachment hole 61. Therefore, the rotational position of the antenna terminal 25 according to the present embodiment around its axis needs to be adjusted to the attachment hole 61 to insert the connection portion 62 through the attachment hole 61.

Two steps 63, 63 extending in the circumferential direction of the connection portion 62 along the flange 25C are cut on the outer circumferential surface of the connection portion 62. The steps 63, 63 are provided to expand from the H-cut surfaces 62A, 62A to the outer circumferential surface having the thread groove 25B. The steps 63, 63 are laid out line-symmetrically with respect to the central axis of the antenna terminal 25.

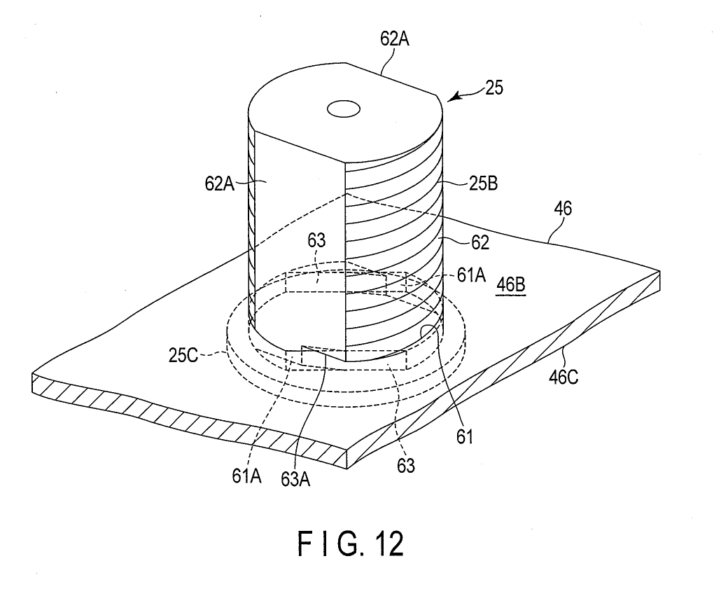

The depth of each of the steps 63, 63 is designed so that each of the steps 63, 63 can be engaged with each of the H-cut portions 61A, 61A of the attachment hole 61 when the antenna terminal 25 is attached to the attachment hole 61 as shown in FIG. 12. The two steps 63, 63 respectively extend in such a direction as to engage with the corresponding H-cut portions 61A, 61A of the attachment hole 61 when the connection portion 62 of the antenna terminal 25 is inserted through the attachment hole 61 and then rotated in an arrow II direction in FIG. 11 (right-hand thread direction).

When the antenna terminal 25 having the structure described above is attached to the attachment hole 61, the connection portion 62 of the antenna terminal 25 is first inserted through the attachment hole 61 from its distal side along the arrow I direction as shown in FIG. 11. At the same time, the two H-cut surfaces 62A, 62A of the connection portion 62 are respectively aligned with the two H-cut portions 61A, 61A of the attachment hole 61, and the connection portion 62 is inserted through the attachment hole 61 from the side of the second surface 46C of the support plate 46. When the entire length of the connection portion 62 is then inserted through the attachment hole 61, the flange 25C contacts the second surface 46C of the support plate 46, and the connection portion 62 protrudes on the side of the first surface 46B of the support plate 46.

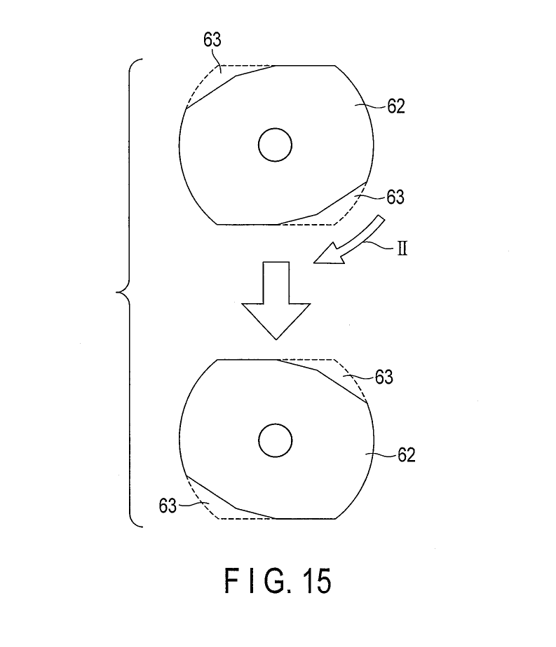

Subsequently, the connection portion 62 of the antenna terminal 25 protruding on the side of the first surface 46B of the support plate 46 is rotated in the right-hand thread direction (arrow II direction in FIG. 15), and the two steps 63, 63 of the connection portion 62 are respectively engaged with the two H-cut portions 61A, 61A of the attachment hole 61. In this condition (condition in FIG. 12), the two H-cut portions 61A, 61A of the attachment hole 61 abut on walls 63A (see FIG. 11) located apart from the flange 25C of each step 63, thereby preventing the connection portion 62 from coming off the attachment hole 61.

In the present embodiment as well, the wall 63A of the step 63 is slightly inclined so that the step 63 may not be disengaged as a result of the rotation of the connection portion 62 in the opposite direction. That is, the width of the step 63 is gradually reduced so that the wall 63A of the step 63 presses the first surface 46B of the H-cut portion 61A of the support plate 46 toward the flange 25C when the connection portion 62 is rotated in the arrow II direction. In this case, the wall 63A of the step 63 functions as a holding portion which holds the support plate 46 between this holding portion and the flange 25C.

As described above, according to the attachment structure in the present embodiment, the antenna terminal 25 can be easily and robustly fixed to the support plate 46 without any additional component, and advantageous effects similar to the advantageous effects according to the first embodiment described above can be provided. Moreover, according to the present embodiment, the H-cut surfaces 62A, 62A facing each other are provided in the connection portion 62 of the antenna terminal 25, so that the space can be saved accordingly, and the mounting space on the substrate 21 can be secured.

In the present embodiment as well, it is preferable to provide solder cream between the outer circumferential portion of the flange 25C and the second surface 46C of the support plate 46 after the antenna terminal 25 is attached to the support plate 46 (FIG. 12), as in the first embodiment described above.

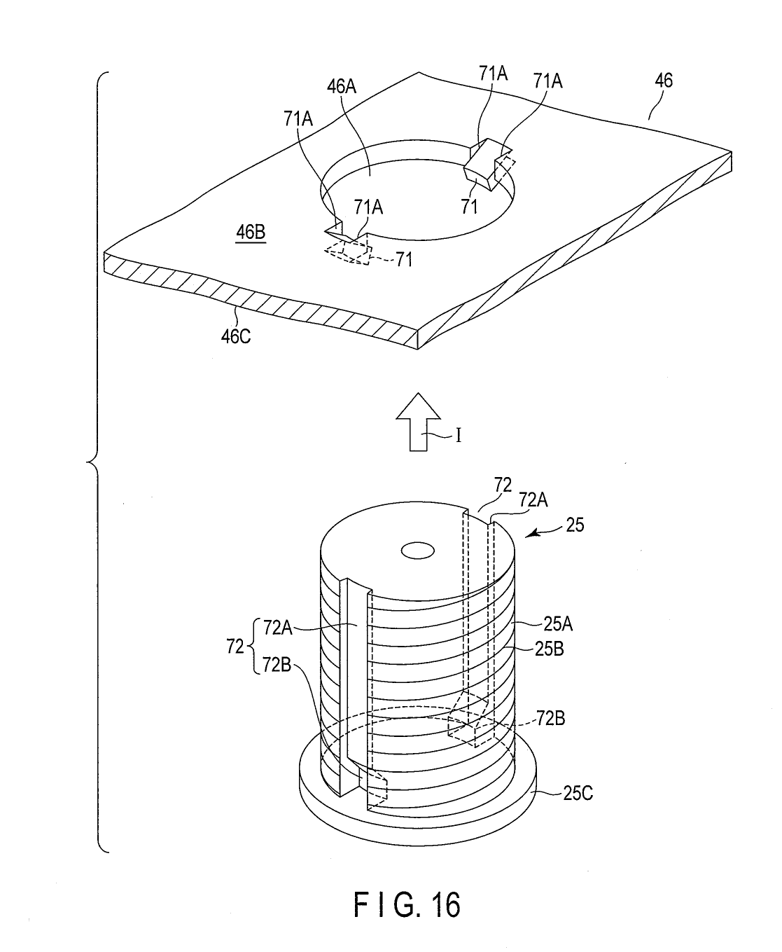

Now, an attachment structure according to a third embodiment is described with reference to FIG. 16 to FIG. 21. Here, components which function in the same manner as the components in the first embodiment described above are indicated by the same reference signs, and are not repeatedly described in detail.

As shown in FIG. 16 and FIG. 18, the support plate 46 has two projections 71, 71 protruding inward from the edge of the substantially circular attachment hole 46A. The two projections 71, 71 are laid out symmetrically with respect to the center of the attachment hole 46A. Each of the projections 71, 71 is bent to incline to the side of the second surface 46C of the support plate 46. Cuts 71A, 71A are respectively provided on both sides of each of the projections 71, 71 in the width direction. The bending position of the projection 71 in the support plate 46 is located outside the edge of the attachment hole 46A.

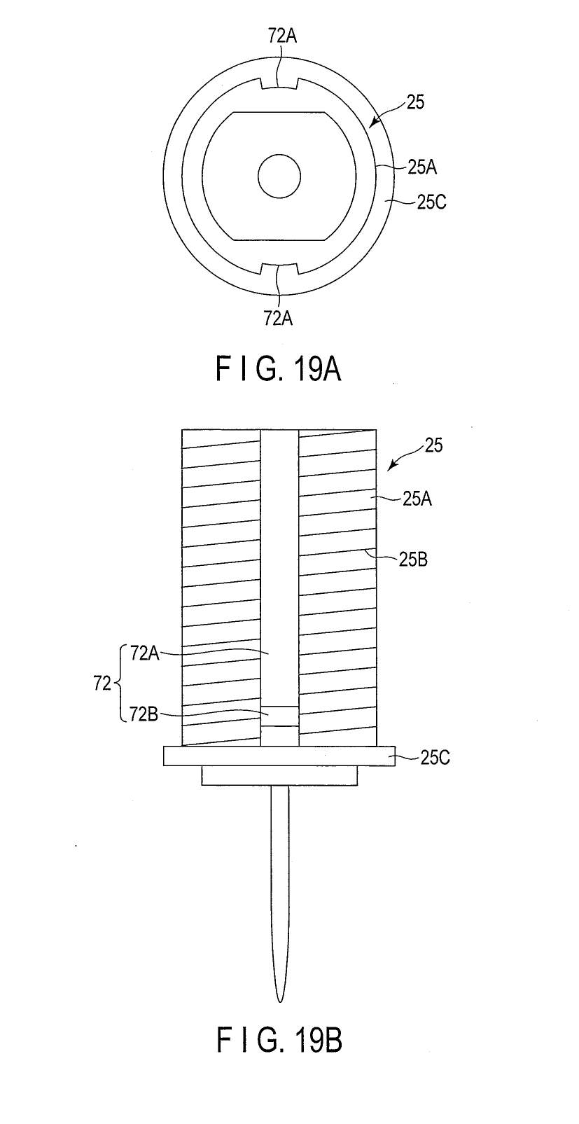

On the other hand, as shown in FIG. 16 and FIG. 19B, the antenna terminal 25 has two engaging grooves 72, 72 axially extending on the outer circumferential surface of the connection portion 25A. The two engaging grooves 72, 72 are laid out line-symmetrically with respect to the central axis of the antenna terminal 25 to correspond to the two projections 71, 71 of the support plate 46. Each of the engaging grooves 72, 72 has a longitudinal groove part 72A (groove part) which slidably receives each of the projections 71, 71 during the insertion of the connection portion 25A through the attachment hole 46A, and a bore part 72B (engaging bore part) provided adjacent to the flange 25C continuously from the proximal end of the longitudinal groove part 72A. The bore part 72B is cut deeper than the longitudinal groove part 72A.

The projections 71 of the support plate 46 and the engaging grooves 72 of the connection portion 25A are not limited to the number in the present embodiment. One pair or three or more pairs may be provided.

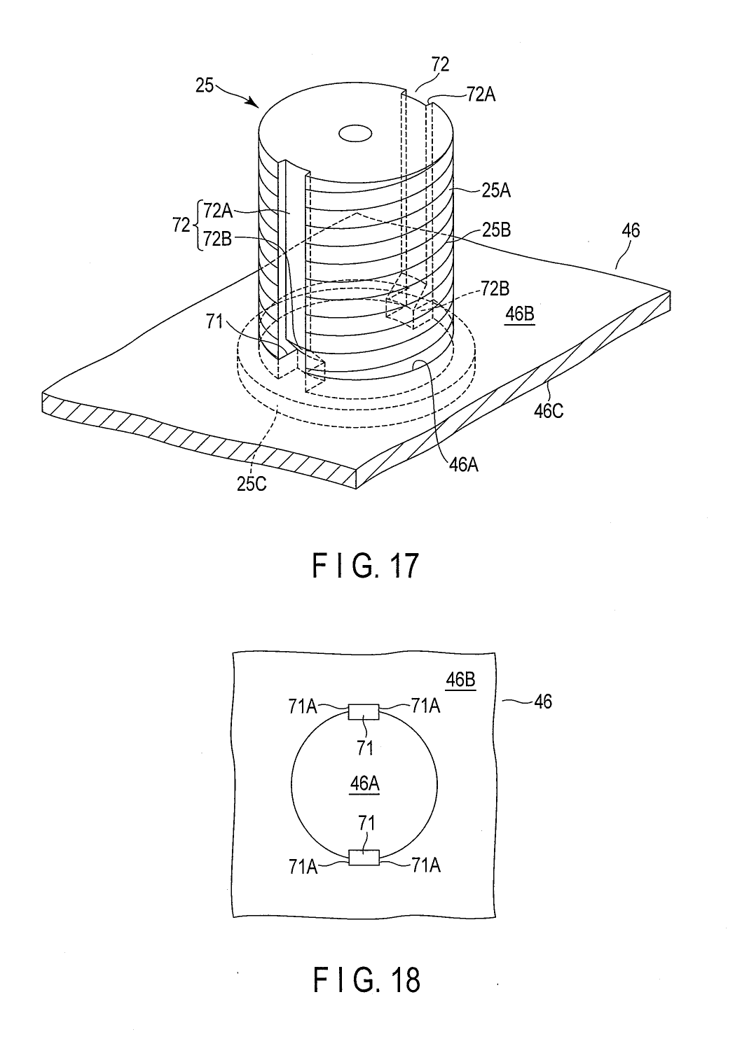

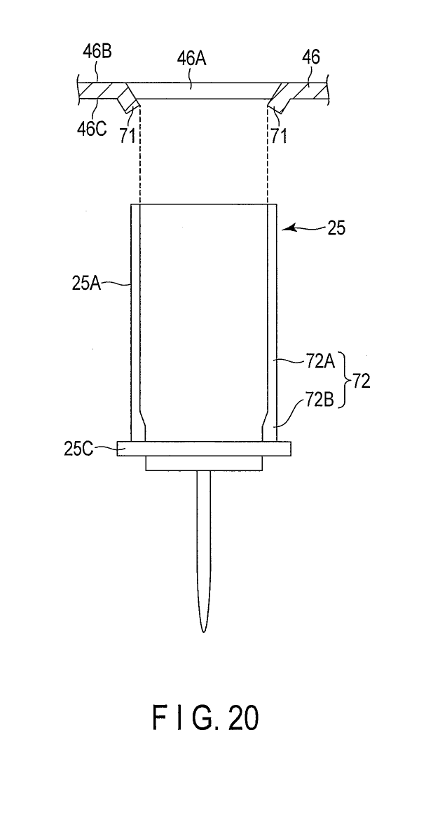

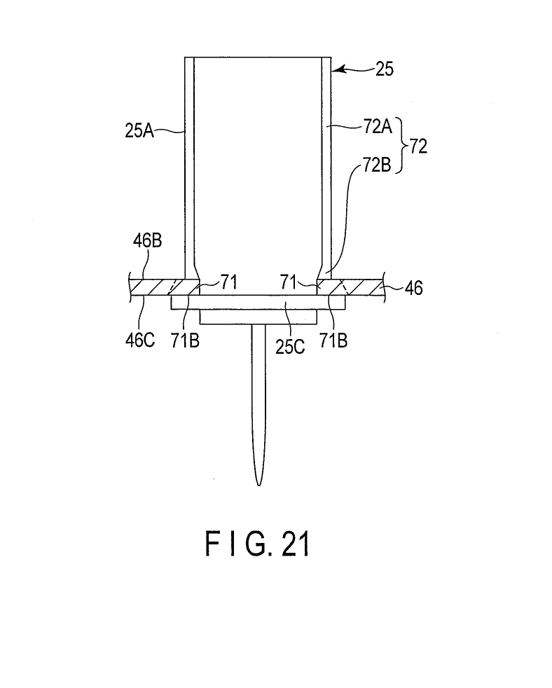

The depth of each longitudinal groove part 72A is designed to the a minimum depth (see FIG. 20) that can simultaneously receive the two projections 71 in a bent condition (condition in FIG. 16). The depth of the bore part 72B is designed to the a minimum depth that can receive the two projections 71, 71 restored to the non-inclined condition when the antenna terminal 25 is attached to the support plate 46 as shown in FIG. 17 and FIG. 21.

In other words, the two projections of the support plate 46 are designed to have a protruding length and an inclination angle that allow the bent projections to be received in the longitudinal groove part 72A and that allow the projections restored to the non-inclined condition to be received in the bore part 72B.

When the antenna terminal 25 having the structure described above is attached to the attachment hole 46A, the connection portion 25A of the antenna terminal 25 is first inserted through the attachment hole 46A from its distal side along the arrow I direction as shown in FIG. 16. At the same time, the two engaging grooves 72, 72 of the connection portion 25A are respectively aligned with the two projections 71, 71 of the attachment hole 46A, and the connection portion 25A is inserted through the attachment hole 46A from the side of the second surface 46C of the support plate 46.

Immediately before the entire length of the connection portion 25A is inserted through the attachment hole 46A and then the flange 25C contacts the second surface 46C of the support plate 46, the distal ends of the bent two projections 71, 71 contact the flange 25C. If the connection portion 25A is pressed in further in the arrow I direction, the two projections 71, 71 are pressed by the flange 25C, and the inclined projections 71, 71 are restored to a straight condition. In this condition, the flange 25C of the antenna terminal 25 abuts on the second surface 46C of the support plate 46.

In this condition (condition in FIG. 17 and FIG. 21), surfaces 71B (FIG. 21) which are flush with the second surfaces of the two projections 71, 71 abut on the flange 25C, so that it is possible to prevent the connection portion 25A from falling out of the attachment hole 46A. That is, in this case, the bore part 72B of each engaging groove 72 functions as a holding portion which holds the support plate 46 (projection 71) between this holding portion and the flange 25C.

As described above, according to the attachment structure in the present embodiment, the antenna terminal 25 can be easily and robustly fixed to the support plate 46 without any additional component, and advantageous effects similar to the advantageous effects according to the first embodiment described above can be provided. Moreover, according to the present embodiment, the projections 71, 71 are pressed by the operation of inserting the connection portion 25A of the antenna terminal 25 through the attachment hole 46A of the support plate 46 so that the antenna terminal 25 can be attached to the support plate 46. This can simplify the process of operation.

In the present embodiment as well, it is preferable to provide solder cream between the outer circumferential portion of the flange 25C and the second surface 46C of the support plate 46 after the antenna terminal 25 is attached to the support plate 46 (FIG. 17), as in the first embodiment described above.

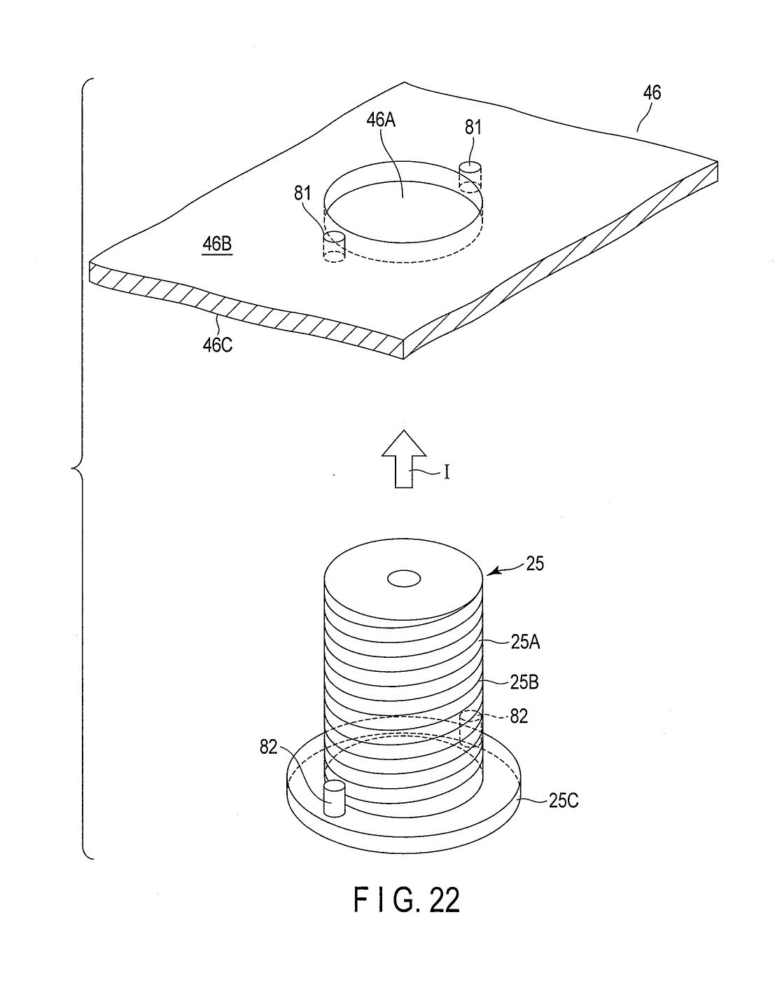

Now, an attachment structure according to a fourth embodiment is described with reference to FIG. 22 to FIG. 25A and FIG. 25B. Here, components which function in the same manner as the components in the first embodiment described above are indicated by the same reference signs, and are not repeatedly described in detail.

As shown in FIG. 22 and FIG. 24, the support plate 46 has the circular attachment hole 46A, and has two small through-holes 81, 81 in the vicinity of the edge of the attachment hole 46A. The two through-holes 81, 81 are laid out symmetrically with respect to the center of the attachment hole 46A.

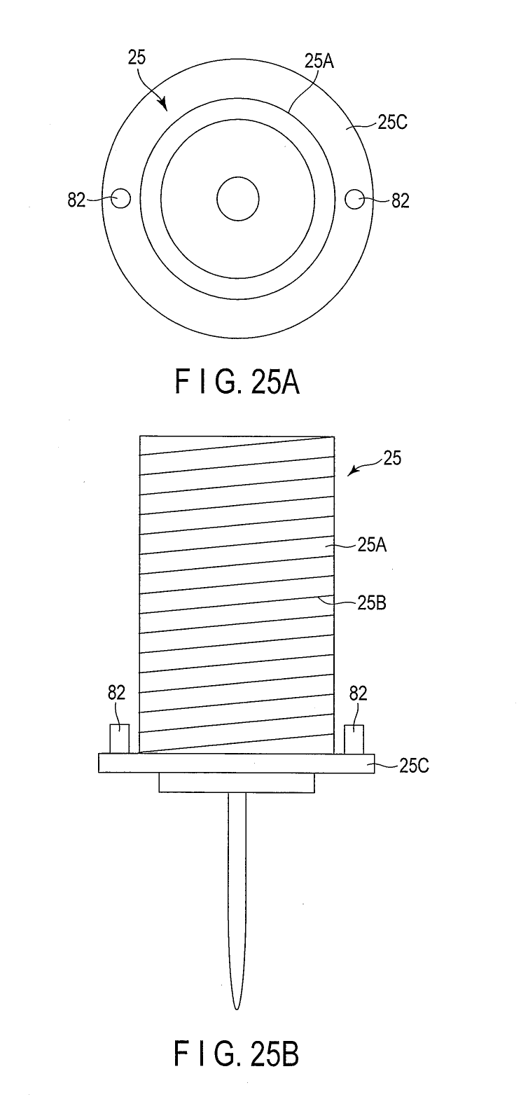

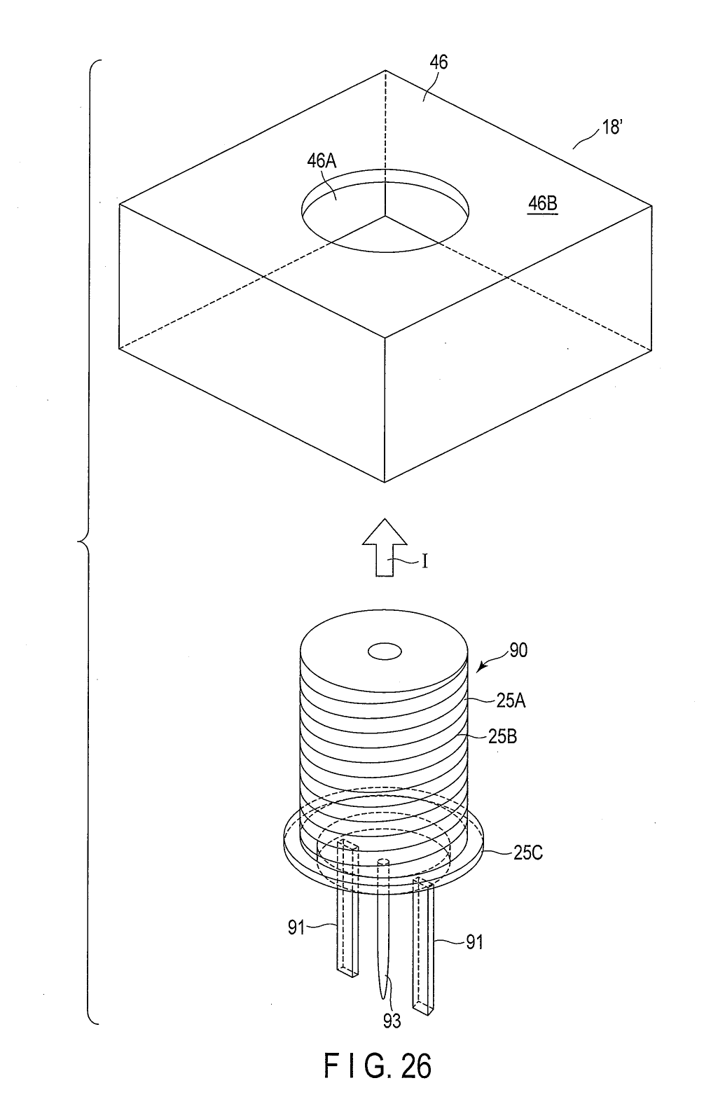

On the other hand, as shown in FIG. 22, FIG. 25A and FIG. 25B, two pins 82, 82 axially extending along the connection portion 25A protrude in the flange 25C of the antenna terminal 25. The two pins 82, 82 are laid out line-symmetrically with respect to the central axis of the antenna terminal 25 to correspond to the two through-holes 81, 81 of the support plate 46.

The outer diameter of the pin 82 protruding in the flange 25C is slightly smaller than the inner diameter of the through-hole 81 of the support plate 46. The length of the pin 82 is larger than the thickness of the support plate 46 (i.e. the length of the through-hole 81). The through-holes 81 of the support plate 46 and the pins 82 of the flange 25C are not limited to the number in the present embodiment. One pair or three or more pairs may be provided.

When the antenna terminal 25 having the structure described above is attached to the attachment hole 46A, the connection portion 25A of the antenna terminal 25 is first inserted through the attachment hole 46A from its distal side along the arrow I direction as shown in FIG. 22. At the same time, the two pins 82, 82 of the flange 25C are respectively aligned with the two through-holes 81, 81 of the support plate 46, and the connection portion 25A is inserted through the attachment hole 46A from the side of the second surface 46C of the support plate 46.

When the entire length of the connection portion 25A is inserted through the attachment hole 46A and then the flange 25C contacts the second surface 46C of the support plate 46, the two pins 82, 82 of the flange 25C are respectively inserted through the two through-holes 81, 81 of the support plate 46, and the distal ends of the pins 82, 82 slightly protrude from the through-holes 81, 81.

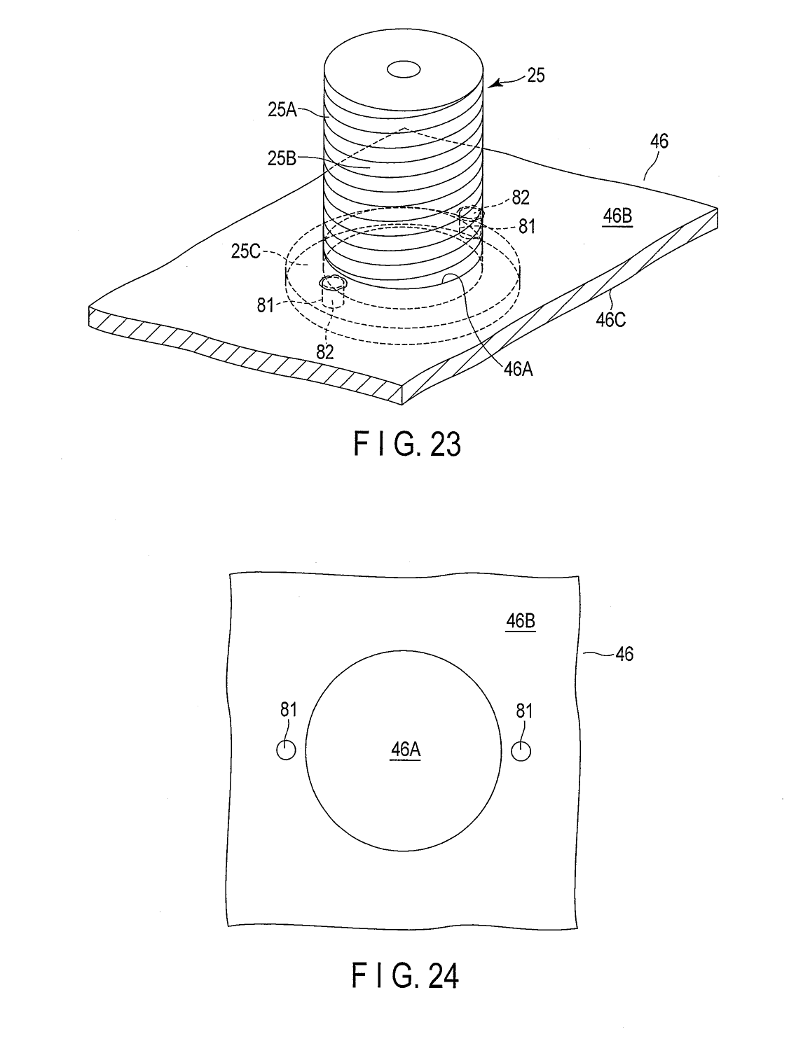

Subsequently, as shown in FIG. 23, the heads of the pins 82, 82 protruding from the through-holes 81, 81 are crushed to prevent the pins 82, 82 from coming off the through-holes 81, 81. In this case, the crushed head of each of the pins 82, 82 functions as a holding portion which holds the support plate 46 between this holding portion and the flange 25C.

As described above, according to the attachment structure in the present embodiment, the antenna terminal 25 can be easily and robustly fixed to the support plate 46 without any additional component, and advantageous effects similar to the advantageous effects according to the first embodiment described above can be provided. Moreover, according to the present embodiment, the pin 82 protrudes in the flange 25C, so that the width of the flange 25C is inevitably increased, which can further ameliorate the problem of the antenna terminal 25 that comes off the attachment hole 46A.

In the present embodiment as well, it is preferable to provide solder cream between the outer circumferential portion of the flange 25C and the second surface 46C of the support plate 46 after the antenna terminal 25 is attached to the support plate 46 (FIG. 23), as in the first embodiment described above.

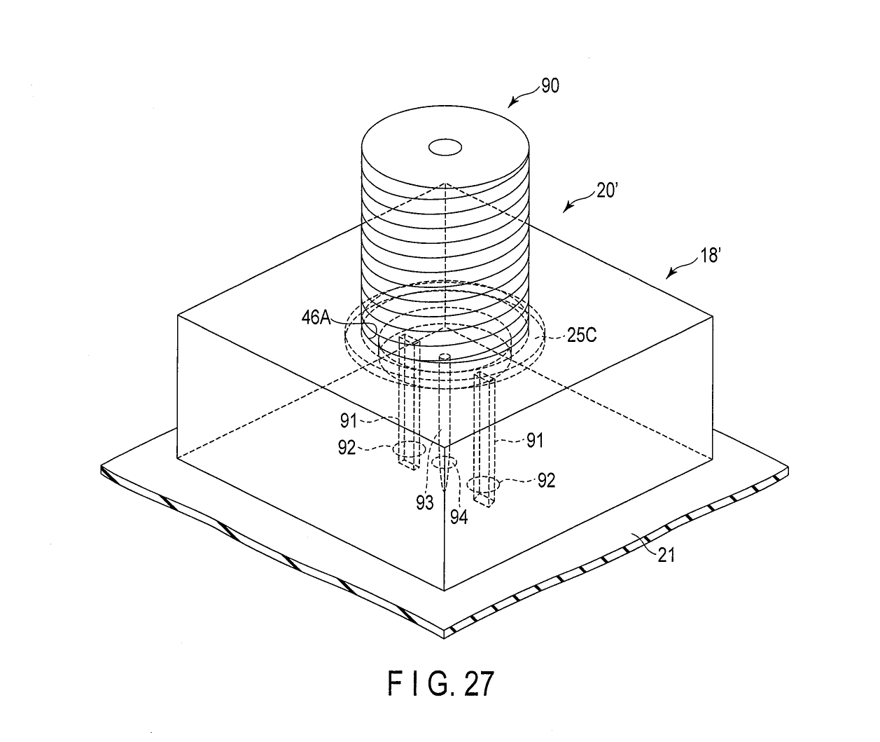

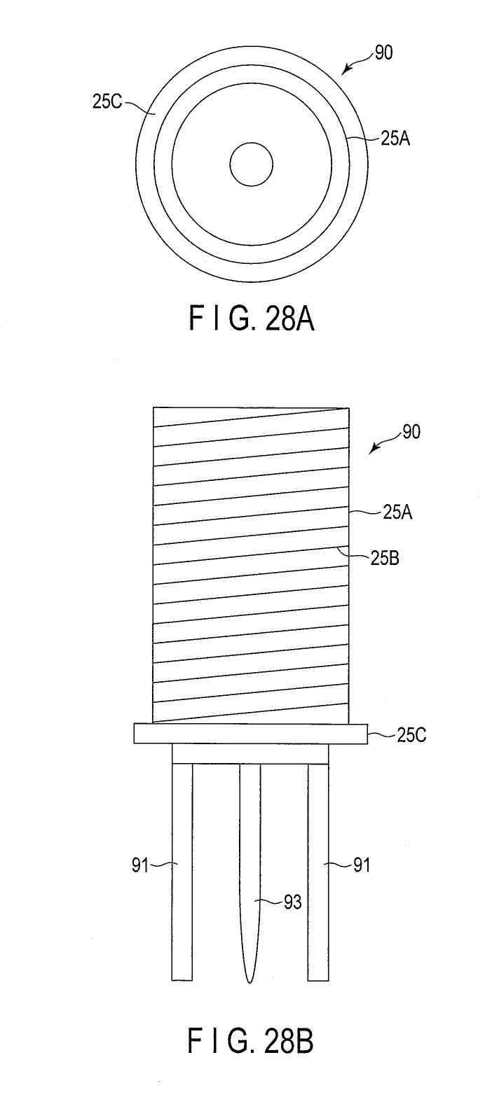

Now, a modification of the first to fourth embodiments is described with reference to FIG. 26 to FIG. 28. FIG. 26 is an exemplary exploded perspective view illustrating the operation of attaching an antenna terminal 90 to a shield case 18′. FIG. 27 is an exemplary perspective view showing how a terminal unit 20′ in which the antenna terminal 90 is attached to the shield case 18′ is mounted on the substrate 21. FIG. 28A is an exemplary plan view of the antenna terminal 90. FIG. 28B is an exemplary side view of the antenna terminal 90. The shield case 18′ is the shield case 18 in FIG. 4 shown in a simplified form.

Although not shown in the present modification, any one of the attachment structures described above in the first to fourth embodiments may be used as the structure for attaching the antenna terminal 90 to the shield case 18′. Moreover, in the present modification, when the terminal unit 20′ in which the antenna terminal 90 is attached to the shield case 18′ is mounted on the substrate 21 as shown in FIG. 27, two connection legs 91, 91 extending from the bottom of the antenna terminal 90 toward the substrate 21 are fixed to holes 92, 92 in the substrate 21.

Although the two connection legs 91, 91 are provided across a connection line 93 extending from the bottom of the antenna terminal 90 in the present modification, the number of the connection legs 91 is not limited. One connection leg 91 or three or more connection legs 91 may be provided. Each of the connection legs 91 may be soldered to the substrate 21.

As described above, according to the present modification, the antenna terminal 90 can be firmly attached to the support plate 46 of the shield case 18′, and the connection legs 91, 91 extending from the antenna terminal 90 can be fixed to the substrate 21. This further ensures that the coming off of the antenna terminal 90 can be prevented.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A unit comprising:
a casing comprising a first surface, a second surface opposite to the first surface, and an attachment hole which extends between the first surface and the second surface; and
a connection terminal comprising a connection portion inside the attachment hole and protruding from the first surface, a flange at a proximal end of the connection portion and which has a size that prevents the flange from passing through the attachment hole and which faces the second surface, and a holding portion which holds the casing between this holding portion and the flange to face the first surface.

2. The unit of claim 1, wherein the connection terminal integrally comprises the connection portion, the flange, and the holding portion.

3. The unit of claim 1, wherein the connection portion comprises, in an outer circumferential surface thereof, a thread groove for cable connection.

4. The unit of claim 1, wherein the casing comprises a projection protruding inward from the edge of the attachment hole,
the connection terminal comprises an axially extending first groove part which slidably receives the projection, the connection portion in the attachment hole, and a second groove part extending continuously from the first groove part in the circumferential direction of the connection portion along the flange, and
the connection portion in the attachment hole and the projection in the second groove part, the second groove functioning as the holding portion.

5. The unit of claim 4, wherein the second groove part extends in a direction to receive the projection, the connection portion protruding on the side of the first surface and the connection portion in the attachment hole.

6. The unit of claim 4, wherein the second groove part comprises a press surface which is inclined so that the projection is pressed toward the flange by the rotation.

7. The unit of claim 1, wherein the connection portion comprises a step cut along the flange, and
the step engages with the first surface of the edge of the attachment hole, the connection portion in the attachment hole.

8. The unit of claim 1, wherein the casing comprises a projection protruding inward from the edge of the attachment hole and inclined toward the second surface,
the connection terminal comprises an axially extending groove part which slidably receives the projection, the connection portion in the attachment hole, and an engaging bore part formed by deepening the groove part along the flange, and
the connection portion in the attachment hole, and the flange is then pressed toward the second surface, whereby the projection is pressed, and the inclined projection is restored and then engaged with the engaging bore part.

9. The unit of claim 1, wherein the flange comprises a pin axially extending along the connection portion,
the casing comprises a through-hole which is located adjacent to the attachment hole to receive the pin, and
the distal end of the pin which protrudes on the side of the first surface through the through-hole is crushed, the connection portion in the attachment hole and the flange faces the second surface.

10. The unit of claim 1, wherein the connection terminal further comprises a connection leg extending up to a substrate to mount the connection terminal provided on the second surface of the casing.

11. An electronic device comprising:
a substrate;
an electronic component on the substrate;
a casing comprising a first surface, a second surface which is opposite to the first surface and which faces the substrate, and an attachment hole which extends between the first surface and the second surface, the casing being attached to the substrate; and
a connection terminal comprising a connection portion in the attachment hole from a side of the second surface and protruding from the first surface, a flange at a proximal end of the connection portion in an insertion direction and which has a size that prevents the flange passing through the attachment hole and which faces the second surface, and a holding portion which holds the casing between this holding portion and the flange to face the first surface.

12. The electronic device of claim 11, wherein the connection terminal integrally comprises the connection portion, the flange, and the holding portion.

13. The electronic device of claim 11, wherein the connection portion comprises, in an outer circumferential surface thereof, a thread groove for cable connection.

14. The electronic device of claim 11, wherein the casing comprises a projection protruding inward from the edge of the attachment hole,
the connection terminal comprises an axially extending first groove part which slidably receives the projection, the connection portion in the attachment hole, and a second groove part extending continuously from the first groove part in the circumferential direction of the connection portion along the flange, and
the connection portion in the attachment hole and the projection in the second groove part, the second groove functioning as the holding portion.

15. The electronic device of claim 14, wherein the second groove part extends in a direction to receive the projection, the connection portion protruding on the side of the first surface and the connection portion in the attachment hole.

16. The electronic device of claim 14, wherein the second groove part comprises a press surface which is inclined so that the projection is pressed toward the flange by the rotation.

17. The electronic device of claim 11, wherein the connection portion comprises a step cut along the flange, and
the step engages with the first surface of the edge of the attachment hole, the connection portion in the attachment hole and then rotated.

18. The electronic device of claim 11, wherein the casing comprises a projection which protrudes inward from the edge of the attachment hole and is then inclined toward the second surface,
the connection terminal comprises an axially extending groove part which slidably receives the projection, the connection portion in the attachment hole, and an engaging bore part formed by deepening the groove part along the flange, and
the connection portion in the attachment hole, and the flange is then pressed toward the second surface, whereby the projection is pressed, and the inclined projection is restored and then engaged with the engaging bore part.

19. The electronic device of claim 11, wherein the flange comprises a pin axially extending along the connection portion,
the casing comprises a through-hole which is located adjacent to the attachment hole to receive the pin, and
the distal end of the pin which protrudes on the side of the first surface through the through-hole is crushed, the connection portion in the attachment hole so that the flange faces the second surface.

20. The electronic device of claim 11, wherein the connection terminal further comprises a connection leg extending up to the substrate.
